(19) United States
(12) Patent Application Publication
(10) Pub. No.: US 2013/0325754 A1
(43) Pub. Date: Dec. 5, 2013

(54) Residential Housing Complex

(71) Applicant: Steven Sounyoung Yu, Rockville, MD (US)

(72) Inventor: Steven Sounyoung Yu, Rockville, MD (US)

(21) Appl. No.: 13/792,203

(22) Filed: Mar. 11, 2013

Related U.S. Application Data
(60) Provisional application No. 61/655,441, filed on Jun. 4, 2012.
(60) Provisional application No. 61/680,698, filed on Aug. 7, 2012.
(60) Provisional application No. 61/708,859, filed on Oct. 2, 2012.
(60) Provisional application No. 61/711,145, filed on Oct. 8, 2012.
(60) Provisional application No. 61/730,500, filed on Nov. 27, 2012.

(51) Int. Cl. G06Q 50/20

(52) U.S. Cl. CPC G06Q 50/20
USPC 705/500

(57) ABSTRACT

A residential housing complex that includes a school. The school (e.g. primary and/or secondary school) uses a machine-guided teaching curriculum. For example, the school can implement a blended learning curriculum. The residential housing complex may be located in urban areas to provide better schools for families with children.

### CROSS-REFERENCES

This application claims the benefit of U.S. Provisional Application Ser. No. 61/655,441 (filed 4 Jun. 2012), No. 61/680,698 (filed 7 Aug. 2012), No. 61/708,859 (filed 2 Oct. 2012), No. 61/711,145 (filed 8 Oct. 2012), and No. 61/730,500 (filed 27 Nov. 2012), all of which are incorporated by reference herein.

### TECHNICAL FIELD

The present invention relates to residential housing.

### BACKGROUND

Many Americans desire to live in urban areas, such as cities, towns, or inner/close-in suburbs, as compared to outer suburban or rural areas. There are many benefits to living in urban areas, including better quality of life for the individual (such as avoiding long commutes and easier access to culture, entertainment, food, and social interactions), as well as benefits to society as a whole (such as increasing the tax base for the city and allowing living practices that reduce strain on the environment).

For people without children, living in an urban area is an attractive option. However, for families with school-age children, the lack of good public schools is a serious disadvantage to living in urban areas. In fact, even parents of young children who enjoy living in the city will often move to the outer suburbs once their children reach school-age. Thus, there is a need to provide better options that would encourage families with school-age children to live in urban areas instead of the outer suburbs.

### SUMMARY

In one embodiment, the present invention provides a residential housing complex comprising multiple housing units provided in one or more residential buildings; and a school (e.g. primary and/or secondary school) that uses a machine-guided teaching curriculum. The school is associated with the multiple housing units or residential building(s), or the owners or residents thereof. In some embodiments, the school is located within 2,500 meters of the residential building(s).

In another embodiment, the present invention provides a method of providing primary and/or secondary education to students, comprising providing education services (e.g. providing online content, hardware, software, electronic media, books, worksheets, teachers, or teacher training, etc.) to a school in a residential housing complex of the present invention. In another embodiment, the present invention provides a method of providing primary and/or secondary education to students using (e.g. owning, having, managing, operating, maintaining, etc.) a residential housing complex of the present invention. The method may further comprise receiving education services (e.g. online content, hardware, software, electronic media, books, worksheets, teachers, or teacher training, etc.) for the school of the residential housing complex.

In another embodiment, the present invention provides a method of developing real estate, comprising making a residential housing complex of the present invention. In another embodiment, the present invention provides a method of making a residential housing complex with a group of homes that comprises multiple housing units provided in one or more residential buildings. The method comprises constructing the primary and/or secondary school of the present invention within 2,500 meters of the residential building(s) and within the boundaries of the residential housing complex. In some cases, the group of homes are pre-existing. In some cases, the method further comprises constructing homes in the residential housing complex, which may involve adding new homes to pre-existing homes or constructing an entire new set of homes for the residential housing complex.

In another embodiment, the present invention provides a method of attracting or retaining families with school-age children to reside in an urban area by using (e.g. constructing, owning, having, managing, operating, maintaining, allowing, permitting, providing, encouraging, inviting, supporting, funding, etc.) a residential housing complex of the present invention in the urban area. The urban area may be an area with overcrowded and/or poorly-performing public schools, thereby attracting families with school-age children to live in an urban area with overcrowded and/or poorly-performing public schools.

In another embodiment, the present invention provides a method for a parent to provide primary and/or secondary education to their children. The method comprises residing in a home of a residential housing complex of the present invention; sending children that live in the home to the school; and paying for the school through tuition payments, homeowner's assessments, or a combination of both.

In another embodiment, the present invention provides a method of allowing more women to enter the workforce by using (e.g. constructing, owning, having, managing, operating, maintaining, allowing, permitting, providing, encouraging, inviting, supporting, funding, etc.) a residential housing complex of the present invention, thereby freeing more women from having to ferry children to and from school.

### BRIEF DESCRIPTION OF THE DRAWINGS

FIG. 1 shows an example of a residential housing complex of the present invention.

FIG. 2 shows another example of a residential housing complex of the present invention.

### DETAILED DESCRIPTION

The present invention provides a residential housing complex that facilitates the education of students living in that housing complex by providing a school that uses a machine-guided teaching curriculum. The machine-guided teaching may be implemented using any suitable machine for interacting with students, including computers (e.g. desktop, laptop, or tablet), robots, and interactive display systems. The machine-guided teaching curriculum may be online (e.g. Web-based) or offline (e.g., software-based, CDs, DVDs, etc). The machine-guided teaching can be implemented to give students some degree of control over the time, place, path, and/or pace of the delivery of the teaching.

In some embodiments, the machine-guided teaching may be combined with face-to-face teaching. In some cases, the machine-guided teaching provides at least 30% of the student didactic instruction time (the time used for listening and/or watching didactic, instructional material; but not counting the time for non-didactic activities such as group activities or projects, playtime or recess, science labs, live demonstrations, and other experiential learning activities); in some cases, at least 40% of the student didactic instruction time. In some cases, the school primarily uses a machine-guided teaching curriculum, in which students interact primarily (greater than 50% of the student didactic instruction time) with a machine instead of a teacher (in-person). Thus, a machine-guided teaching curriculum can reduce face-to-face interaction time with teachers as compared to traditional or conventional teaching approaches used in primary or secondary schools in the United States. Examples of such types of schools include hybrid online schools or blended learning schools that combine traditional face-to-face teaching with online learning.

The residential housing complex comprises multiple housing units provided in one or more residential buildings (collectively “homes”). In some embodiments, there are at least 30 housing units in the residential housing complex; in some cases, at least 50 housing units; in some cases, at least 75 housing units; in some cases, at least 100 housing units in the residential housing complex. In embodiments that include a multi-story residential building, in some cases, the building has at least 6 floors, including the ground floor.

Examples of residential buildings include condominiums (providing multiple condominium units), apartment buildings (providing multiple apartment units), townhouses (each providing one housing unit, or more than one, such as a duplex), co-ops, rowhouses, detached single-family homes, etc. If the residential complex has multiple buildings, the buildings may be organized in any suitable fashion, such as being clustered together or dispersed within a neighborhood. As such, the residential complex can have any suitable form, including neighborhood, community, development, association, enclave, etc.

In some embodiments, the residential housing complex is designed to be particularly suitable for families with children. For example, at least 60% of the housing units may have at least two bedrooms; in some cases, at least 70%; in some cases, at least 80% have at least two bedrooms. In another example, at least 30% of the housing units may have at least three bedrooms; in some cases, at least 40%; in some cases, at least 50% have at least three bedrooms.

In some embodiments, at least 50% of the housing units in the residential housing complex have only 2-4 bedrooms; in some cases, at least 60%; in some cases, at least 70% have only 2-4 bedrooms. This would provide a greater number of moderate-sized homes that are more affordable for moderate-income families, thereby attracting families with moderate incomes to live in the residential housing complex.

In some embodiments, the homes in the residential housing complex are part of a common-interest development (also referred to as “common-interest community” or other similar term, depending upon the jurisdiction). There are various types of common-interest developments, such as master-planned communities, planned-unit developments, planned single-family home developments, gated or walled communities, condominiums, and housing cooperatives. As a common-interest development, the group of homes may be subject to a set of covenants, conditions, and restrictions (also called CC&Rs). Examples of common-interest developments (e.g. communities or residential/mixed-used developments) that are existing or under construction include King Farm, Fallsgrove, Rockville Town Square, and Crown Farm in Montgomery County, MD; Reston Town Center and MetroWest in Fairfax County, VA; Pentagon Row in Arlington, Va.; The Yards and CityCenterDC in Washington, D.C.; Time Warner Center in New York City, N.Y.

Typically, the boundaries of the common-interest development are defined by a publicly-available real estate recording document (e.g. master deed, enabling declaration, declaration of conditions, CC&R, etc.) filed with a local government authority that keeps land records (e.g. Recorder of Deeds). The real estate recording document may also contain rules for the operation of the common-interest development, such as a CC&R. In some embodiments, the school may be located on land that (i) is part of the common-interest development, or (ii) is within or adjacent the boundaries of the common-interest development and to which the home owners have right of private use (e.g. leased, grant from one of the home owners, etc.). In some embodiments, the homes and the school are part of the same common-interest development.

The homes and school are located within the boundaries of the residential housing complex. In some embodiments, the boundaries of the residential housing complex are defined by a publicly-available real estate recording document (e.g. master deed, enabling declaration, declaration of conditions, CC&R, etc.) filed with a local government authority that keeps land records (e.g. Recorder of Deeds). The boundaries of the residential housing complex may be designated by any conventional manner in which land use is planned or land is developed for residential (or mixed-use) purposes. For example, the residential housing complex may be designated according to: real estate, land use, housing, residential, or mixed-use development/redevelopment project or plan; development or land use plan or proposal submitted to a government authority (e.g. public works department, planning commission, zoning board, etc.); plat (e.g. for consolidation or subdivision); parcel or group of parcels; or subdivision or group of subdivisions.

In some embodiments, the school is located on land that is owned by one or more owners of the homes, individually or collectively through a community governing entity as described below; or the school is located on land that the one or more owners of the homes, individually or collectively through a community governing entity (as described below) have right of private use (e.g. through leasing or easement). In some embodiments, the school is located on land that is a commons property of the residential housing complex.

In some embodiments, the homes of the residential housing complex (or the residential housing complex as a whole) may be defined by the manner in which it was developed. In some cases, the homes are built under the direction of the same developer or development team. In some cases, the homes are built according to the same development plan (e.g. master development plan). In some cases, both the homes and the school are built under the direction of the same developer or development team. In some cases, both the homes and the school are built according to the same development plan (e.g. master development plan).

The school of the present invention does not have to be constructed simultaneously with or as part of the same original plan/design as the residential building(s) that make up the residential housing complex. For example, a school of the present invention can be added to an existing residential neighborhood or condominium building. In another example, the homes may be constructed around a school to provide a residential housing complex of the present invention.

In some embodiments, the group of homes are governed by a community governing entity that represents the owners of the homes (e.g. homeowner's association, including condominium association, co-op board, etc.). The community governing entity may collect assessments (homeowner's dues, fees, etc.) from the owners/residents. The community governing entity may be responsible for providing services, upkeep of community amenities, management, security, etc., of the residential housing complex. While the individual homes may be individually owned, the commons properties are controlled by the community governing entity that represents the joint ownership of these commons properties among the individual owners. The community governing entity may be private or public. In some embodiments, the school is a commons property of the residential housing complex that is controlled (e.g. owned or operated) by the community governing entity. In some embodiments, the school is located on land that is controlled (e.g. owned or leased) by the community governing entity.

In some embodiments, the homes may share ownership or private right of access to commons properties, such as recreation facility(s), gym/fitness facility(s), clubhouse(s), park(s), playground(s), community center(s), swimming pool(s), tennis court(s), outdoor open space(s) such as commons greenery(s), fence(s), parking area(s) including garage(s), sidewalk(s), building lobby(s), building hallway(s), and/or building gathering space(s). In some embodiments, one or more of the preceding commons properties may also be shared with the school. In some embodiments, the homes may share common services, such as landscaping services. In some embodiments, a community governing entity may represent the joint ownership of these commons properties by the home owners. In some embodiments, the residential housing complex has a storm water retention/detention area and multiple homes in the residential housing complex share this storm water retention/detention area.

It is also possible that the homes that constitute the residential housing complex may be those in which its resident children (if any) are eligible (exclusive or priority enrollment) to attend the school of the present invention, as explained above. In other words, for example, those homes that are designated to be eligible to have children residents (if any) for exclusive or priority enrollment in the school can be considered as being part of the residential housing complex. It is also possible that the homes that are included in the residential housing complex are those within a certain proximity to the school, as explained above.

The residential housing complex of the present invention may also include commercial, industrial, office, institutional, or other land uses. For example, the residential housing complex may include grocery stores, drug stores, coffee shops, retail stores, restaurants, convenience stores, health clubs or gyms, office buildings, parking, etc. For example, the residential housing complex may be a mixed-use development.

The school may include any or all primary school and/or secondary school grade levels, which may correspond with different terminologies in different parts of the United States, including K-12 grade levels, or preschool, kindergarten, elementary school (e.g. kindergarten and grade levels 1-5), middle school (e.g. grade levels 6-8), intermediate school, high school (e.g. grade levels 9-12), junior high school, and senior high school (e.g. grade levels 10-12).

Because the school may serve a smaller community of students, the school may be smaller than a typical school. In some embodiments, the school may have less than 25 classrooms; in some cases, less than 20; in some cases, less than 15; in some cases, less than 10 classrooms (not including recreational areas such as playroom, gym, or amphitheater). In some embodiments, the school may have less than 150 students; in some cases, less than 100; in some cases, less than 75; in some cases, less than 50.

In some embodiments, the school may be designed for a capacity of fewer than 300 students; in some cases, fewer than 250; in some cases, fewer than 200; in some cases, fewer than 150 students. In some embodiments, the school may have fewer than 20 full-time certified/licensed teachers; in some cases, fewer than 15; in some cases, fewer than 10 full-time certified/licensed teachers. In some embodiments, the school occupies a floor space of less than 120,000 sq. ft. (as net usable square feet); in some cases, less than 90,000 sq. ft.; in some cases, less than 75,000 sq. ft.; in some cases, less than 60,000 sq. ft.; in some cases, less than 50,000 sq. ft.; in some cases, less than 40,000 sq. ft.; in some cases, less than 30,000 sq. ft.; in some cases, less than 25,000 sq. ft.

In some embodiments, the school has a school-wide student to certified/licensed teacher ratio of 20 or more; in some cases, 25 or more; in some cases, 30 or more. In some embodiments, the school has at least one teaching paraprofessional who is not certified/licensed (e.g. teaching assistant, teacher's aide, instructional assistant, classroom assistant, or other teaching-related position that assists the certified or licensed teacher); in some cases, at least two teaching paraprofessionals; in some cases, at least three teaching paraprofessionals; in some cases, at least five teaching paraprofessionals.

The school of the present invention is not intended to be a daycare. As such, in some embodiments, the school has at least one certified or licensed teacher; in some cases, at least two; in some cases, at least three. In some embodiments, the school includes at least grade level 1 or higher (e.g. grade levels K-6); in some cases, at least grade level 2 or higher; in some cases, at least grade level 3 or higher (e.g. grades levels 1-5 or grade levels 6-8).

The residential housing complex of the present invention is not intended to encompass a boarding school or a college/university setting. In the homes of the residential housing complex, the students reside with their parent(s) or legal guardian(s). As such, the residential housing complex is not a college/university dormitory, a student housing apartment for a college/university, etc. Also, the school of the present invention is not intended to be a homeschool setting, and thus, is not located inside a housing unit (e.g. an individual condominium, or townhouse, or dormitory room). The school has a real physical setting (i.e. is “brick-and-mortar,” not completely virtual) and has at least one instructor who is not a parent or legal guardian of the students; in some embodiments, at least three instructors who are not a parent or legal guardian of the students.

The school may be accredited. For example, the school may be accredited by an accrediting organization that has been authorized by a state or federal authority. For example, the accrediting organization may be one that accredits private schools (i.e. the school of the present invention is a private school, and for this instance, one that is accredited by an organization that accredits private schools) or online schools. The school may have at least 12 students; and in some embodiments, at least 15; and in some embodiments, at least 20.

The school of the present invention is not intended to be a public school. The meaning of “public school” is as conventionally understood, i.e., directly paid for by or dependent upon government funding or taxpayer contributions, and/or administered by a government body (e.g. local, state, or federal). Public schools include charter schools, magnet schools, or other types of specialized public schools.

Instead, the school of the present invention is a private school (the term “private school” as used herein is intended to include independent schools), which in contrast to public schools, is not directly dependent upon government funding or taxpayer contributions, and not administered by a government body. Instead, the school is funded by, for example, tuition from parents, through a private source, and/or through government-funded vouchers given to parents. For example, the residents and/or home owners who are parents of the students may pay tuition to the school, or the school may receive funding from a community governing entity (e.g., through homeowner's assessments or a special fee paid by the residents/owners), or a combination thereof.

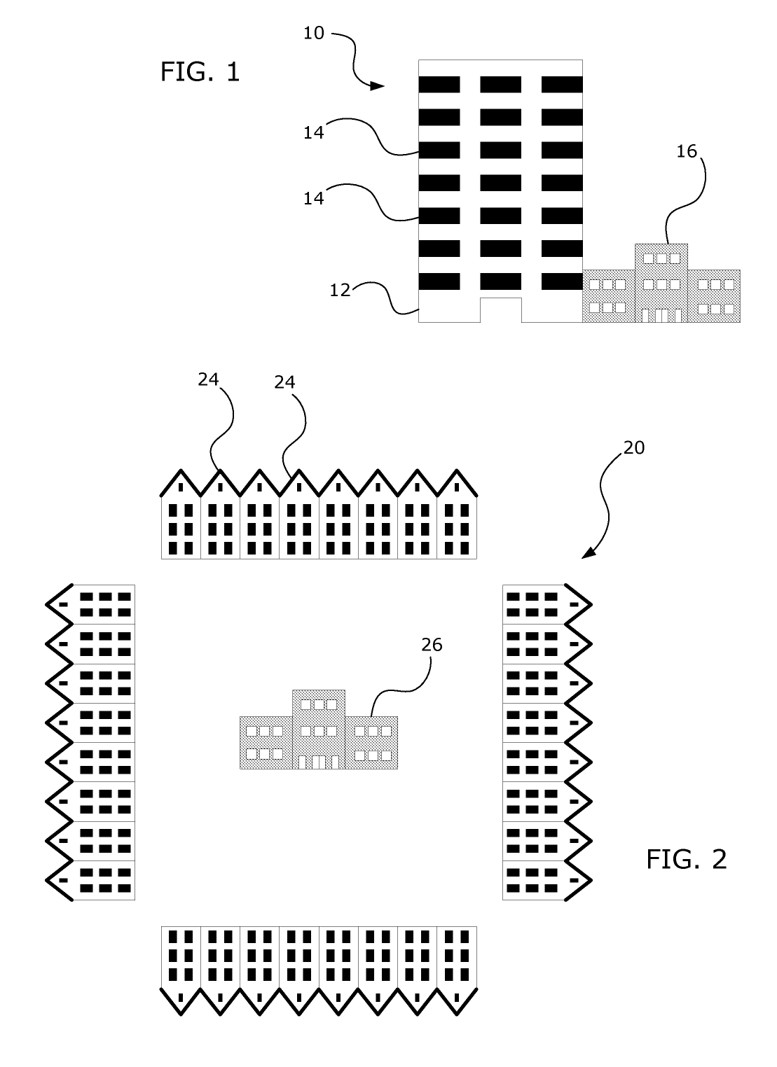

In some embodiments, the school may be within or attached to a residential building. For example, the residential housing complex may be a single condominium building having multiple housing units, and the school is inside or attached to the condominium building (e.g., a high-rise residential condominium with a school at the ground floor of the building). For example, FIG. 1 shows a residential housing complex 10 that comprises a condominium building 12 and a school 16 of the present invention attached to the building 12. The condominium building 12 comprises multiple condominium units 14. In an alternate embodiment, the school 16 may be located inside the condominium building 12 (e.g. on the ground floor).

In embodiments wherein the school is within or attached to a residential building, in some cases, the school area is accessible from the residential area inside the residential building and/or the residential area inside of the residential building is accessible from the school area. That is, a student inside the residential area could enter the school area without having to exit to the outside of the building (e.g. to the outside street or sidewalk); and/or a student in the school area can enter the residential area without having to exit to the outside of the building. In some cases, the residential building has at least one entryway (e.g. doorway) from the outside (e.g. to the outside street or sidewalk) that also serves as an entryway for access to the school. For example, the residential building may have a main entryway and lobby, which also serves as the main entryway (from the outside) for the school, which may be located elsewhere inside the residential building (and possibly through other internal entryways, such as a door separating the residential area from the school area of the building). In some cases, the school does not have a separate entryway from the outside. That is, the school area is accessed only through the same entryway(s) used to enter the residential building. In some cases, in addition to the common entryway(s), the school may have its own separate entryway(s) for entering the school.

In embodiments wherein the school is within or attached to a residential building, the school may be structurally integrated with the residential building. In some cases, at least one horizontal structural beam and/or at least one vertical column of the residential building is also part of the school construction. The school may share external facade features with the residential building. In some cases, the school shares with the residential building, at least one of the following facade elements: building facade material, window design, or color scheme; in some cases, at least two of the preceding facade elements; in some cases, all three of the preceding facade elements. In some cases, the residential building has at least one elevator that serves both a residential area and a school area; in some cases, at least two elevators that are shared with the school area.

In embodiments wherein the school is within or attached to a residential building, in some cases, the residential building has a heating, ventilation, and air-conditioning (HVAC) system, in which at least one component of the HVAC system also serves the school. For example, the residential building may share with the school area a same heating apparatus (e.g. furnace) or same air-conditioning apparatus (e.g. rooftop air-conditioning apparatus). In some cases, the residential building has a central heating apparatus, a central air conditioning apparatus, and/or a ventilation exhaust that also serves the school area. In some cases, the HVAC system for the residential building also serves the school area. In some cases, at least one of the ventilation air ducts that serve the school area are part of the ventilation air duct system for the residential building.

In embodiments wherein the school is within or attached to a residential building, one or more commons property of the residential building may be shared with the school. Examples of such commons properties include recreation facility(s), gym/fitness facility(s), swimming pool(s), building lobby(s), building hallway(s), and/or building gathering space(s).

In embodiments wherein the school is within or attached to a residential building, in some cases, a garbage and/or recycling area or facility for the residential building is also used by the school. In embodiments wherein the school is within or attached to a residential building, in some cases, a room or area for building mechanical equipment (e.g. HVAC), building electrical equipment (e.g. electrical distribution panels), and/or building telecommunications equipment (e.g. for telephone lines, cable lines, etc.) for the residential building is shared with the school.

However, the school is not necessarily attached to any of the residential buildings. For example, the school may be detached from any residential building in the residential housing complex but located within walking distance of the residential buildings. For example, the school may be located on the same street as a condominium building, or the same block as a condominium building, or be located within or next to a cluster of townhouses or rowhouses, in the community center for a residential development, etc. For example, FIG. 2 shows a residential housing complex 20 that comprises a cluster of townhouse units 24. There is a school 26 of the present invention in the middle of the cluster of townhouse units 24.

The school may be located within walking distance of the residential building(s). For example, the school may be located within 2,500 meters of all the residential building(s); or in some embodiments, within 2,000 meters; or in some embodiments, within 1,500 meters; or in some embodiments, within 1,000 meters; or in some embodiments, within 500 meters of all the residential building(s). These distance ranges include the school being within or attached to a residential building. Having a school within walking distance can have numerous advantages, including not having to rely on school bus transportation, starting school at later times in the morning (which has beneficial effects on student health and well-being by avoiding sleep deprivation and harmonizing with the natural biological clock of adolescents, and increasing alertness in school, all of which can improve academic performance as well), avoiding long travel routes to school, freeing parents from having to ferry children to and from school, etc.

The owners/operators of the school do not have to be the same entity as the owners/operators of the homes. Even if they are different entities, they may collaborate to provide primary and/or secondary education to students. For example, the owners/operators of a condominium building may allow another entity to operate a school within the condominium building; or, for example, the owners/operators of a residential community/neighborhood may allow another entity to operate a school within the neighborhood area. The present invention is intended to include such arrangements.

In some embodiments, the school may be provided exclusively for residents of the residential housing complex. In other embodiments, the school may be open to enrollment for students who are not residents of the residential housing complex (but those residing in the residential housing complex could be given priority enrollment privileges). In embodiments where the school is open to enrollment for students who are not residents of the residential housing complex, in some cases, the school may have more than 70% of the student enrollment from residents of the residential housing complex (residing in the homes); or in some embodiments, more than 75%; or in some embodiments, more than 80%; or in some embodiments, more than 90% of the student enrollment from residents of the residential housing complex. In some embodiments, to help promote diversity in the student body, at least 20% of the students in the school are not residents of the residential housing complex.

In some embodiments, the residential housing complex is located in an area that is zoned (land-use zoning) for at least residential and school use (including those granted as variances, conditional use, limited use, etc.). In some embodiments, the residential housing complex may be located near public transit. For example, the residential complex may be located within 5,000 meters from a passenger railway transit station or stop (e.g. train, subway, light rail, commuter rail, metro, or tram).

In some embodiments, the residential complex is located in an area with academically low-performing public schools, is economically disadvantaged, and/or having overcrowded public schools. In the description of the present invention herein, such areas may be defined by school boundary, zip code, or census tract. For the purposes of understanding the present invention, the census tract is to be taken from the most recent U.S. Census. For example, in the year 2016, the census tracts used in the U.S. Census of 2010 should be applied. In another example, in the year 2022, the census tracts used in the U.S. Census of 2020 should be applied. In many jurisdictions or territories, residential areas are assigned to a school boundary containing one or more specific public schools that are assigned to the residences within that boundary. A residential complex of the present invention may be located within such a school boundary.

In some embodiments, the residential complex is located in an area (defined by school boundary, zip code, and/or census tract) where at least one public school (e.g. high school) has a graduation rate (e.g. that is used to demonstrate Adequate Yearly Progress (AYP) under the No Child Left Behind Act of 2001) of less than 85% in four years; in some embodiments, less than 80%; in some embodiments, less than 75%; in some embodiments, less than 70%; in some embodiments, less than 60% in four years.

In some embodiments, the residential complex is located in an area (defined by school boundary, zip code, and/or census tract) where at least one public school (e.g. high school) has a mathematics SAT® score in the 75th percentile or below of national or state scores; in some embodiments, in the 70th percentile or below; in some embodiments, in the 65th percentile or below; in some embodiments, in the 60th percentile or below; in some embodiments, in the 55th percentile or below; in some embodiments, in the 50th percentile or below; in some embodiments, in the 45th percentile or below; in some embodiments, in the 40th percentile or below.

In some embodiments, the residential complex is located in an area (defined by school boundary, zip code, and/or census tract) where at least one public school (e.g. high school) has a combined SAT® score in the 75th percentile or below of national or state scores; in some embodiments, in the 70th percentile or below; in some embodiments, in the 65th percentile or below; in some embodiments, in the 60th percentile or below; in some embodiments, in the 55th percentile or below; in some embodiments, in the 50th percentile or below; in some embodiments, in the 45th percentile or below; in some embodiments, in the 40th percentile or below.

In some embodiments, the residential complex is located in an area (defined by school boundary, zip code, and/or census tract) where at least one public school (e.g. middle or high school) has less than 85% of the students meet or exceed the state or federal standards for mathematics proficiency; in some embodiments, less than 80%; in some embodiments, less than 75%; in some embodiments, less than 70%; in some embodiments, less than 65%; in some embodiments, less than 60%; in some embodiments, less than 55%; in some embodiments, less than 50%; in some embodiments, less than 45%; in some embodiments, less than 40%; in some embodiments, less than 35%. An example of such a standard are each state's standards for mathematics and reading/language arts proficiency used to demonstrate Adequate Yearly Progress (AYP) under the No Child Left Behind Act of 2001. State standards are publicly available from various known sources, including government sources.

In some embodiments, the residential complex is located in an area (defined by school boundary, zip code, and/or census tract) where at least one public school (e.g. middle or high school) has less than 85% of the students meet or exceed the state or federal standards for reading proficiency; in some embodiments, less than 80%; in some embodiments, less than 75%; in some embodiments, less than 70%; in some embodiments, less than 65%; in some embodiments, less than 60%; in some embodiments, less than 55%; in some embodiments, less than 50%; in some embodiments, less than 45%; in some embodiments, less than 40%; in some embodiments, less than 35%. An example of such a standard are each state's standards for mathematics and reading/language arts proficiency used to demonstrate Adequate Yearly Progress (AYP) under the No Child Left Behind Act of 2001. State standards are publicly available from various known sources, including government sources.

In some embodiments, the residential complex is located in an area (defined by school boundary, zip code, and/or census tract) where at least one public school (e.g. middle or high school) has a GreatSchools™ (www.greatschools.org) rating of 6 or lower; in some embodiments, 5 or lower; in some embodiments, 4 or lower; in some embodiments, 3 or lower.

In some embodiments, the residential complex is located in an area (defined by school boundary, zip code, and/or census tract) where at least one public school (e.g. elementary, middle, or high school) has at least 25% of the students in a free or reduced-price meals program; in some embodiments, at least 30%; in some embodiments, at least 35%; in some embodiments, at least 40% of the students.

In some embodiments, the residential complex is located in an area (defined by school boundary, zip code, and/or census tract) where at least one public school (e.g. elementary, middle, or high school) is over capacity. For example, the public school may be more than 20% over capacity (i.e. 20% more than the number of students that the school was designed or built to serve); in some cases, more than 25% over capacity; in some cases, more than 50% over capacity; and in some cases, more than 100% over capacity. Other indications of school overcrowding may be use of temporary classrooms, such as trailers or other “portables”; conversion of gymnasiums, libraries, teachers' workrooms, and/or storage areas into classrooms; adoption of multi-track schedules where students and teachers rotate being in school and on vacation at different times during the year.

The residential housing complex may be located in an area with relatively higher population density (e.g. within cities or inner suburbs around cities). For example, the residential complex may be located within a zip code and/or census tract having a population density of greater than 1,500 people per square mile; in some embodiments, greater than 2,000; in some embodiments, greater than 2,500; in some embodiments, greater than 3,000; in some embodiments, greater than 4,000; in some embodiments, greater than 5,000; in some embodiments, greater than 7,000 people per square mile.

The residential housing complex may be located within or near a major city. In some embodiments, the residential complex is located in or within 15 miles of the border of a city having a population of at least 350,000 people; in some embodiments, at least 500,000 people; in some embodiments, at least 750,000 people; in some embodiments, at least 1,000,000 people. In some embodiments, the residential complex is located in one of the following cities or within 15 miles of the border of one of the following cities: New York, N.Y.; Los Angeles, Calif.; Chicago, Ill.; Houston, Tex.; Philadelphia, Pa.; Phoenix, Ariz.; San Diego, Calif.; San Antonio, Tex.; Dallas, Tex.; Detroit, Mich.; San Jose, Calif.; Indianapolis, Ind.; Jacksonville, Fla.; San Francisco, Calif.; Columbus, Ohio; Austin, Tex.; Memphis, Tenn.; Baltimore, Md.; Charlotte, N.C.; Fort Worth, Tex.; Boston, Mass.; Milwaukee, Wis.; El Paso, Tex.; Washington, District of Columbia; Nashville-Davidson, Tenn.; Seattle, Wash.; Denver, Colo.; Las Vegas, Nev.; Portland, Oreg.; Oklahoma City, Okla.; Tucson, Ariz.; Albuquerque, N. Mex.; Atlanta, Ga.; Long Beach, Calif.; Kansas City, Mo.; Fresno, Calif.; New Orleans, La.; Cleveland, Ohio; Sacramento, Calif.; Mesa, Ariz.; Virginia Beach, Va.; Omaha, Nebr.; Colorado Springs, Colo.; Oakland, Calif.; Miami, Fla.; Tulsa, Okla.; Minneapolis, Minn.; Honolulu, Hi.; Arlington, Tex.; Wichita, Kans.; St. Louis, Mo.; Raleigh, N.C.; Santa Ana, Calif.; Cincinnati, Ohio; Anaheim, Calif.; Tampa, Fla.; Toledo, Ohio; Pittsburgh, Pa.; Aurora, Colo.; Bakersfield, Calif.; Riverside, Calif.; Stockton, Calif.; Corpus Christi, Tex.; Lexington-Fayette, Ky.; Buffalo, N.Y.; St. Paul, Minn.; Anchorage, Ak.; Newark, N.J.; Plano, Tex.; Fort Wayne, Ind.; St. Petersburg, Fla.; Glendale, Ariz.; Lincoln, Nebr.; Norfolk, Va.; Jersey City, N.J.; Greensboro, N.C.; Chandler, Ariz.; Birmingham, Ala.; Henderson, Nev.; Scottsdale, Ariz.; North Hempstead, N.Y.; Madison, Wis.; Hialeah, Fla.; Baton Rouge, La.; Chesapeake, Va.; Orlando, Fla.; Lubbock, Tex.; Garland, Tex.; Akron, Ohio; Rochester, N.Y.; Chula Vista, Calif.; Reno, Nev.; Laredo, Tex.; Durham, N.C.; Modesto, Calif.; Huntington, N.Y.; Montgomery, Ala.; Boise, Id.; Arlington, Va.; San Bernardino, Calif.

As used herein, “state” means one of the 50 states in the United States of America or the District of Columbia. A listing of the 50 states is as follows: Alabama, Alaska, Arizona, Arkansas, California, Colorado, Connecticut, Delaware, Florida, Georgia, Hawaii, Idaho, Illinois, Indiana, Iowa, Kansas, Kentucky, Louisiana, Maine, Maryland, Massachusetts, Michigan, Minnesota, Mississippi, Missouri, Montana, Nebraska, Nevada, New Hampshire, New Jersey, New Mexico, New York, North Carolina, North Dakota, Ohio, Oklahoma, Oregon, Pennsylvania, Rhode Island, South Carolina, South Dakota, Tennessee, Texas, Utah, Vermont, Virginia, Washington, West Virginia, Wisconsin, and Wyoming.

It is possible that the present invention can be used to promote racial, ethnic, and/or socioeconomic diversity. For example, by lowering the cost of education, more middle class Americans can move from the suburbs to the cities. Increasing racial, ethnic, and/or socioeconomic diversity can be achieved by various means. For example, some of the housing units may be reserved for lower-income families (e.g. Section 8 or housing voucher tenants). As such, there may be more occupancy by minority families (e.g. black, Hispanic/Latino, or Asian). For example, in some embodiments, at least 20% of the housing units may be occupied by member(s) of a minority racial/ethnic group. In another example, in some embodiments, at least 20% of the housing units may be reserved for low-income families.

In recognition that demographics and population characteristics, and even geographic boundaries, can change over time, the demographic parameters and geographic designations (such as zip codes or city boundaries) herein are to be taken from the most recently available data, such as the most recent U.S. Census data or other such data. For example, in the year 2016, a person may refer to the U.S. Census of 2010, or other more recent data, if available. In another example, in the year 2022, a person may refer to the U.S. Census of 2020 for data relating to the present invention. In another example, in the year 2018, even if the zip code boundaries have changed since the 2010 Census, the zip code boundaries in the 2010 Census should be used in reference to the present invention; or more recent official data, if such is available (e.g. data produced by a local government).

Each of the above-disclosed aspects, embodiments, variations, and/or characteristics of the invention may be considered individually or in any combination. The foregoing description and examples have been set forth merely to illustrate the invention and are not intended to be limiting. Each of the disclosed aspects and embodiments of the present invention may be considered individually or in combination with other aspects, embodiments, and variations of the invention. In addition, unless otherwise specified, none of the steps of the methods of the present invention are confined to any particular order of performance. Modifications of the disclosed embodiments incorporating the spirit and substance of the invention may occur to persons skilled in the art and such modifications are within the scope of the present invention.

Many prior attempts at attracting families with school-age children to live in urban areas have been unsuccessful. By providing residential housing in combination with high quality, affordable education in urban areas, the present invention causes a new synergistic effect—attracting more families to move from their isolating suburban enclaves into urban areas or retaining families with school-age children to continue living in urban areas instead of moving to the outer suburbs. The synergistic effects of the present invention can finally be successful in drawing more families to live in urban areas, instead of the outer suburbs.

Moreover, because the school is part of the residential housing complex, there can be a synergistic effect of allowing more women to enter the workforce. Without the need to ferry children to and from school, more mothers can be freed to re-enter the workforce after childbearing.

I claim:

1. A residential housing complex comprising:
a group of homes comprising multiple housing units provided in one or more residential buildings; and
a primary and/or secondary school that uses a combination of machine-guided and face-to-face teaching, the school being located within the boundaries of the residential housing complex.

2. The residential housing complex of claim 1, wherein the school is located within 2,500 meters of the residential building(s).

3. The residential housing complex of claim 2, wherein the homes in the residential housing complex are part of a common-interest development.

4. The residential housing complex of claim 2, wherein the homes are governed by a community governing entity that represents the owners of the homes.

5. The residential housing complex of claim 2, wherein the homes share ownership or private right of access to commons properties, and one or more of the commons properties is shared with the school.

6. The residential housing complex of claim 1, wherein the school is within or attached to a residential building.

7. The residential housing complex of claim 6, wherein the school area is accessible from the residential area inside the residential building and/or the residential area inside of the residential building is accessible from the school area.

8. The residential housing complex of claim 6, wherein the residential building has a heating, ventilation, and air-conditioning (HVAC) system, and wherein at least one component of the HVAC system also serves the school.

9. The residential housing complex of claim 6, wherein a commons property of the residential building is shared with the school.

10. The residential housing complex of claim 1, wherein the school occupies a floor space of less than 90,000 sq. ft.

11. The residential housing complex of claim 1, wherein the residential complex is located in a zip code or school boundary where at least one public school has a mathematics SAT® score in the 75th percentile or below of national or state scores, or less than 85% of the students meet or exceed the state or federal standards for mathematics proficiency.

12. The residential housing complex of claim 1, wherein the residential complex is located within a zip code having a population density of greater than 1,500 people per square mile.

13. The residential housing complex of claim 1, wherein the residential complex is located in one of the following cities or within 15 miles of the border of one of the following cities: New York, N.Y.; Los Angeles, Calif.; Chicago, Ill.; Houston, Tex.; Philadelphia, Pa.; Phoenix, Ariz.; San Diego, Calif.; San Antonio, Tex.; Dallas, Tex.; Detroit, Mich.; San Jose, Calif.; Indianapolis, Ind.; Jacksonville, Fla.; San Francisco, Calif.; Columbus, Ohio; Austin, Tex.; Memphis, Tenn.; Baltimore, Md.; Charlotte, N.C.; Fort Worth, Tex.; Boston, Mass.; Milwaukee, Wis.; El Paso, Tex.; Washington, District of Columbia; Nashville-Davidson, Tenn.; Seattle, Wash.; Denver, Colo.; Las Vegas, Nev.; Portland, Oreg.; Oklahoma City, Okla.; Tucson, Ariz.; Albuquerque, N. Mex.; Atlanta, Ga.; Long Beach, Calif.; Kansas City, Mo.; Fresno, Calif.; New Orleans, La.; Cleveland, Ohio; Sacramento, Calif.; Mesa, Ariz.; Virginia Beach, Va.; Omaha, Nebr.; Colorado Springs, Colo.; Oakland, Calif.; Miami, Fla.; Tulsa, Okla.; Minneapolis, Minn.; Honolulu, Hi.; Arlington, Tex.; Wichita, Kans.; St. Louis, Mo.; Raleigh, N.C.; Santa Ana, Calif.; Cincinnati, Ohio; Anaheim, Calif.; Tampa, Fla.; Toledo, Ohio; Pittsburgh, Pa.; Aurora, Colo.; Bakersfield, Calif.; Riverside, Calif.; Stockton, Calif.; Corpus Christi, Tex.; Lexington-Fayette, Ky.; Buffalo, N.Y.; St. Paul, Minn.; Anchorage, Ak.; Newark, N.J.; Plano, Tex.; Fort Wayne, Ind.; St. Petersburg, Fla.; Glendale, Ariz.; Lincoln, Nebr.; Norfolk, Va.; Jersey City, N.J.; Greensboro, N.C.; Chandler, Ariz.; Birmingham, Ala.; Henderson, Nev.; Scottsdale, Ariz.; North Hempstead, N.Y.; Madison, Wis.; Hialeah, Fla.; Baton Rouge, La.; Chesapeake, Va.; Orlando, Fla.; Lubbock, Tex.; Garland, Tex.; Akron, Ohio; Rochester, N.Y.; Chula Vista, Calif.; Reno, Nev.; Laredo, Tex.; Durham, N.C.; Modesto, Calif.; Huntington, N.Y.; Montgomery, Ala.; Boise, Id.; Arlington, Va.; San Bernardino, Calif.

14. The residential housing complex of claim 1, wherein the residential complex is located in a census tract where at least one public school has a mathematics SAT® score in the 75th percentile or below of national or state scores, or less than 85% of the students meet or exceed the state or federal standards for mathematics proficiency.

15. The residential housing complex of claim 1, wherein at least 70% of the housing units have at least two bedrooms.

16. The residential housing complex of claim 1, wherein the residential housing complex is located in an area that is zoned for at least residential and school use.

17. A method of providing primary and/or secondary education to students, comprising providing education services to a residential housing complex of claim 1.

18. A method of providing primary and/or secondary education to students by using a residential housing complex of claim 1.

19. A method of developing real estate, comprising making a residential housing complex of claim 1.

20. A method of attracting or retaining families with school-age children to reside in an urban area by using a residential housing complex of claim 1 within the urban area.
